(19) United States
(12) Patent Application Publication
(10) Pub. No.: US 2016/0144963 A1
(43) Pub. Date: May 26, 2016

(54) DEVICE INTENDED TO IMPROVE THE COMFORT OF PASSENGERS OF A MEANS OF TRANSPORT WITHOUT CHANGING THE PASSENGER CARRYING CAPACITY OF SAME

(71) Applicant: SEBGO, Charce Saint Ellier (FR)

(72) Inventor: Olivier GREGOIRE, Charce Saint Ellier (FR)

(21) Appl. No.: 14/904,611

(22) PCT Filed: Jul. 15, 2014
(86) PCT No.: PCT/FR2014/051818

§ 371 Date: Jan. 12, 2016

(30) Foreign Application Priority Data
Jul. 12, 2013 (FR) 1301649

(51) Int. Cl. B64D 11/06; B64D 11/00

(52) U.S. Cl. CPC B64D 11/0601; B64D 11/0643; B64D 11/003; B64D 11/0627

(57) ABSTRACT

Disclosed is a two-level modular passenger seating structure mounted in the compartment of a transport device, between a floor and a ceiling. The modular structure consists in a rigid structure defined by—two parallel vertical side walls extending parallel to the longitudinal axis,—a rear structure,—a lower structure resting on the floor of the compartment and attached to same, and—an upper structure rigidly connected to the ceiling of the compartment, and lower cells and upper cells between the walls and structures. The lower and upper cells are open to one of the side walls. Passengers access the lower cells of the lower level from the side of one vertical side wall of the rigid structure and at a first level of the compartment, and passengers access the upper cells of the upper lever from the opposite side, at a relatively raised level.

### TECHNICAL FIELD TO WHICH RELATES THE INVENTION

The present invention relates to the general field of transport of passengers. It more particularly relates to a device intended to improve the comfort of the passengers of a means of transport without changing the carrying capacity thereof.

### TECHNOLOGICAL BACK-GROUND

In particular in the case of transport by plane, in the economy classes, the passengers are most of time seated on seats arranged in successive rows.

The spacing between each row is often very limited and the passengers' knees are in contact, or almost in contact, with the back of the seat of the preceding row. This low spacing prevents or strongly limits the possibility to incline the back of the seat to obtain a more comfortable position, in particular to sleep during a long travel.

Moreover, the passengers of the economy classes cannot have any privacy due to the promiscuity and the absence of partitioning.

To remedy these drawbacks, certain solutions have already been proposed in which, for example, two successive rows of seats are offset in height (see in particular the documents US-2006/0060703, U.S. Pat. No. 5,716,026, or US-2009/0066121), but in those cases the passenger carrying capacity is reduced and the improvement of the comfort is not evident, in particular for the passengers of the upper levels.

Other solutions propose superimposed or stepped cabins (see for example the US-2006/0000947), but, if the comfort of the passengers is herein significantly improved, the carrying capacity is highly reduced.

The document US-2002/0033432 proposes another solution with two superimposed floors, the upper floor being corrugated so that the passengers of the lower level can stand up.

This solution is comfortable, but requires, to operate, that the passengers of the upper level are placed in a staggered arrangement with respect to those of the lower level. That way, the spacing between each row of passengers of a same level is of great size and the loss of carrying capacity is significant.

The document DE-3 901 140 describes a passenger seat arrangement structure within the compartment of a vehicle of transport, which vehicle comprises two lateral walls, a floor and a roof.

This seat arrangement structure comprises two rows of cells adapted for receiving passengers in seated position, each on two levels (an upper one and a lower one), and each placed between one of the lateral walls of the vehicle of transport and a central aisle.
It more precisely comprises a substantially elongated general volume, a horizontal and planar lower surface, a plurality of lower cells identical to each other, arranged one after the other on a lower level, and a plurality of upper cells identical to each other, arranged one after the other on an upper level.
The profile of the lower level cells is substantially identical to the profile of the upper level cells, the profiles of each cell including:
a substantially horizontal seating base,
a back substantially inclined with respect to the vertical,
a footrest substantially perpendicular to the back,
a passenger leg rest surface substantially parallel to the back,
a substantially horizontal ceiling,
a front face substantially parallel to the back, and
an upper area located above the passengers' head, substantially perpendicular to the inclined back.
   The seating bases of the upper cells are located opposite the ceiling of the lower cells; the passenger leg rest surfaces of the upper cells are located substantially in the continuation of the backs of the lower cells; the footrests of the upper cells are located opposite the upper areas located above the head of the passengers of the lower cells; and the distance between the lower part of the structure and the bottom point of the footrests of the upper cells is smaller than the distance between the lower part of the rigid structure and the ceilings of the lower cells.
   The upper seating bases are laterally offset with respect to the lower seating bases due to the curved section between the lateral walls and the ceiling.

At each of the rows, the access to the lower and upper cells is performed from the aisle side:
directly from the floor of the compartment for the lower cells, and
through a step of access for the upper cells.

But such an arrangement is not optimum, in terms both of rigidity and of ergonomics. The access to the cells is uneasy and poses problems of security in case of evacuation. Moreover, the gain in capacity of such a structure is not evident due to the presence of only one seat per cell.

It is also known from the document U.S. Pat. No. 4,066,227 a seat arrangement within the compartment of a plane, in which several rows of double seats (herein four) are arranged at equal distance from each other on a floor, corresponding to a first level of seating bases. An upper floor is provided within the compartment, which is accessible through stairs provided in the central part (between the two central rows of double seats), to form a second level of seating bases.

This upper floor has an aisle in the continuation of the access stairs, which aisle is continued by lateral structures of floor each supporting a row of double seats, such lateral structures of floor being continued on the sides by support panels ensuring the link with the ceiling of the compartment.

The vertical space for the passengers is herein very limited because the upper floor is flat and the feet of the upper passengers are hence necessarily located above the ceiling of the lower level.

Within the framework of such an arrangement, it is also necessary to very firmly connect the upper floor to the ceiling of the compartment, because, in case of accident, the weight of the seats and of the passengers located at the upper level is supported in great part by the ceiling of the compartment.

### OBJECT OF THE INVENTION

To remedy these drawbacks, the present invention proposes a two-level modular structure intended to be mounted in the compartment of a means of transport such as a plane, between a floor and a ceiling, for the passengers to seat, which modular structure comprises:
a general volume substantially elongated along a longitudinal axis,
a plurality of lower cells, arranged one after the other along a direction parallel to said longitudinal axis and on a lower level,
a plurality of upper cells, arranged one after the other along a direction parallel to said longitudinal axis and on an upper level located above said lower level,
   such cells being intended to each receive at least one seat structure for a passenger,
   the profiles of the lower cells of the lower level being identical or substantially identical to the profiles of the upper cells of the upper level, each cell having a general profile allowing a seated position, this profiles comprising:
a horizontal or substantially horizontal seating base,
a back inclined with respect to the vertical,
a footrest,
a passenger leg rest surface,
a ceiling,
a front face substantially parallel to the back,
   said seating bases of the upper cells being located opposite the ceilings of the lower cells;
   and said structure is characterized in that it consists in a rigid structure delimited at least by
two vertical lateral walls, parallel to each other, extended along a direction parallel to said longitudinal axis,—a rear structure,—a lower structure intended to rest on the floor of said compartment, and to be fixed to the latter, and—an upper structure intended to be fastened to the ceiling of said compartment, and between which walls and structures are arranged said cells,
   said lower and upper cells are open in any one of said vertical lateral walls,
   the passengers getting to the lower cells of the lower level from the side of a vertical lateral wall of the rigid structure and at a first level of the compartment of the means of transport, and the passengers getting to the upper cells of the upper level from the side of the vertical lateral wall that is opposed to the preceding one of the rigid structure, and at a second level, raised with respect to said first level.

Preferably, this rigid structure is also delimited by a front structure located in the continuation of the lateral walls, of the lower structure and of the upper structure.

According to still other features, the modular structure includes a plurality of lower and upper cells identical or substantially identical to each other, wherein:
said footrest is substantially perpendicular to the back,
said passenger leg rest surface is substantially parallel to the back, said rest surfaces of the upper cells being substantially located in the continuation of the backs of the lower cells,
said ceiling is substantially horizontal,
an upper area intended to be located above the passengers' head is substantially perpendicular to the inclined back,
said footrests of the upper cells are located opposite said upper areas of the lower cells,
the distance between said lower structure and the bottom point of said footrests of the upper cells is smaller than the distance between said lower structure and said ceilings of the lower cells, and
said seating bases of the upper cells are located substantially directly vertically above the seating bases of the lower cells.

Preferably, said front structure and/or said rear structure are in the form of a caisson provided with at least one access opening, possibly closed by a door, to provide a technical room or a toilet room.

According to another feature, the modular structure is made by an assembly of elements made separately, i.e., at least,—bent panels,—bent panel spacers,—lower seating base blocks, —ceiling bases and—lateral walls panels.

On the other hand, the upper structure advantageously integrates or supports a plurality of luggage compartments.

Still preferably, each of the lower and upper cells include at least one seat structure added on its seating base.

According to still another feature, said lower structure includes lower seating base blocks supporting at least certain of the seat structures of the lower cells, and which seating base blocks each integrate at least one luggage compartment provided with an opening associated with a closing flap, said opening being located on the top of said lower seating base block and the seating base of said seat structure being tiltable to form said closing flap.

Each upper cell preferably includes a window in the wall opposite to that of its main access for the passengers.

The invention also relates to an arrangement of a plurality of modular structures as defined hereinabove, in the compartment of a means of transport, said modular structures being placed side by side in said compartment, the longitudinal axes thereof being parallel to each other; moreover, the lower or upper cells correspond to each other in the interval between two modular structures, in order to share the same level of access to the lower or upper cells in said interval.

Within this framework, the compartment preferably includes at least one row of seats fixed to its floor, on each side of the plurality of modular structures.

### DETAILED DESCRIPTION OF SEVERAL EXEMPLARY EMBODIMENTS

The invention will be further illustrated, without being limited in any way, by the following description of several possible embodiments, given only by way of example, in relation with the appended drawings in which:

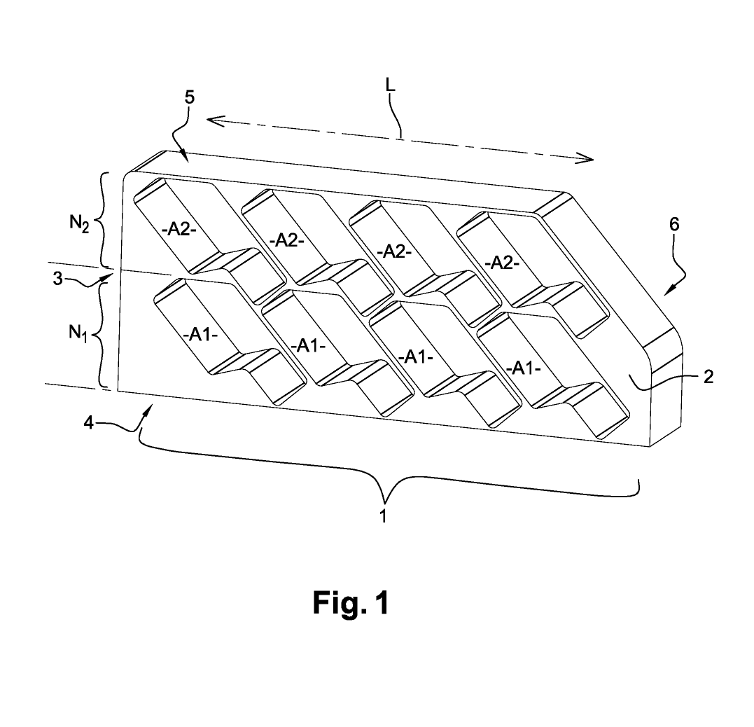

FIG. 1 is a schematic perspective view of a rigid modular structure according to the invention, with through cells;

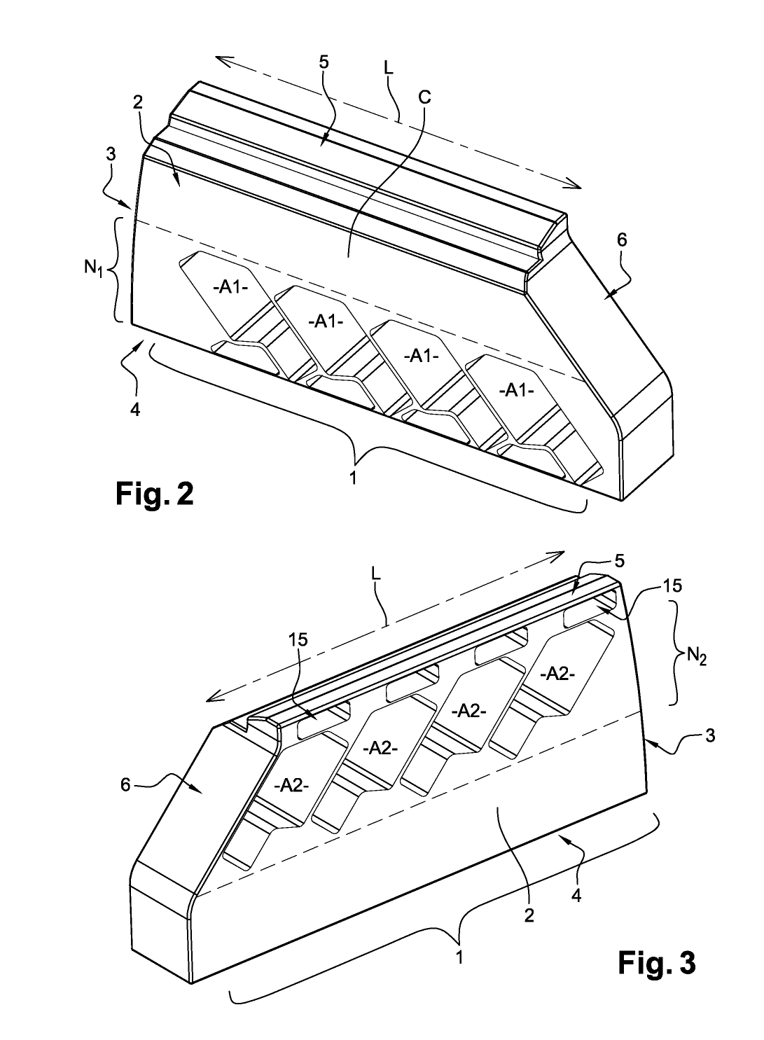

FIG. 2 is a schematic perspective view of a rigid modular structure according to the invention, with the upper cells open on the opposite side with respect to the lower cells, viewed from the side of the opening of the lower cells;

FIG. 3 is a schematic perspective view of a rigid modular structure according to the invention, still with the upper cells open on the opposite side with respect to the lower cells, viewed from the side of the opening of the upper cells;

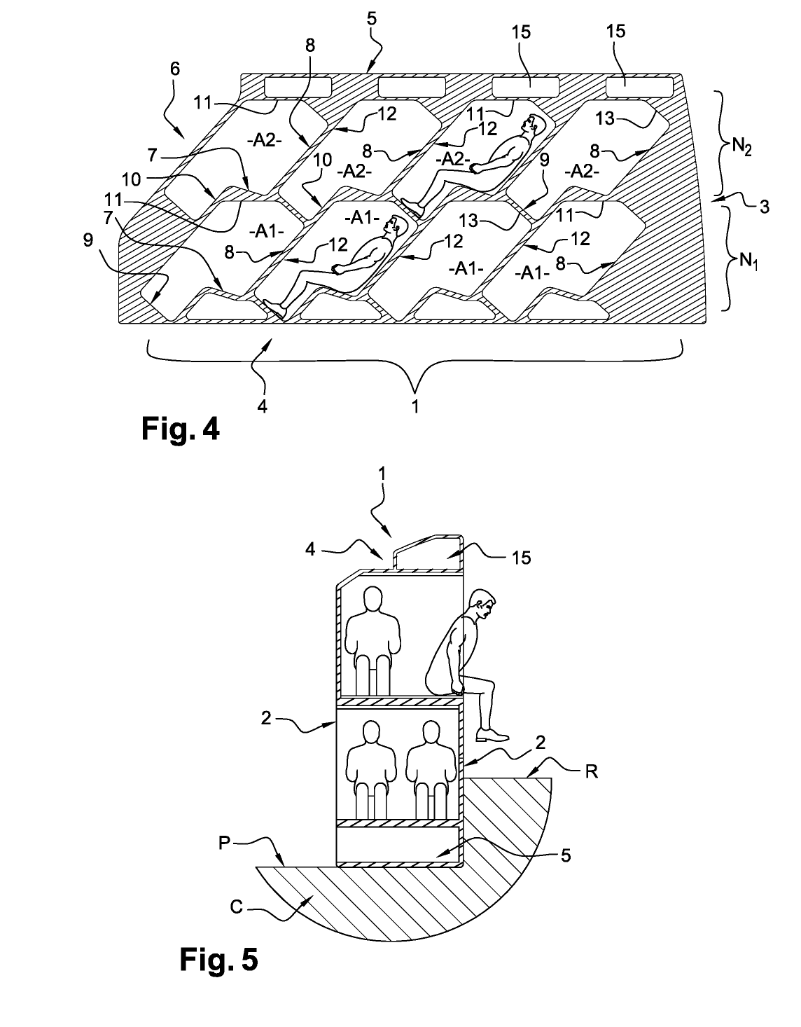

FIG. 4 is a schematic longitudinal section of a rigid structure according to the invention;

FIG. 5 is a schematic cross section of a rigid structure according to the invention;

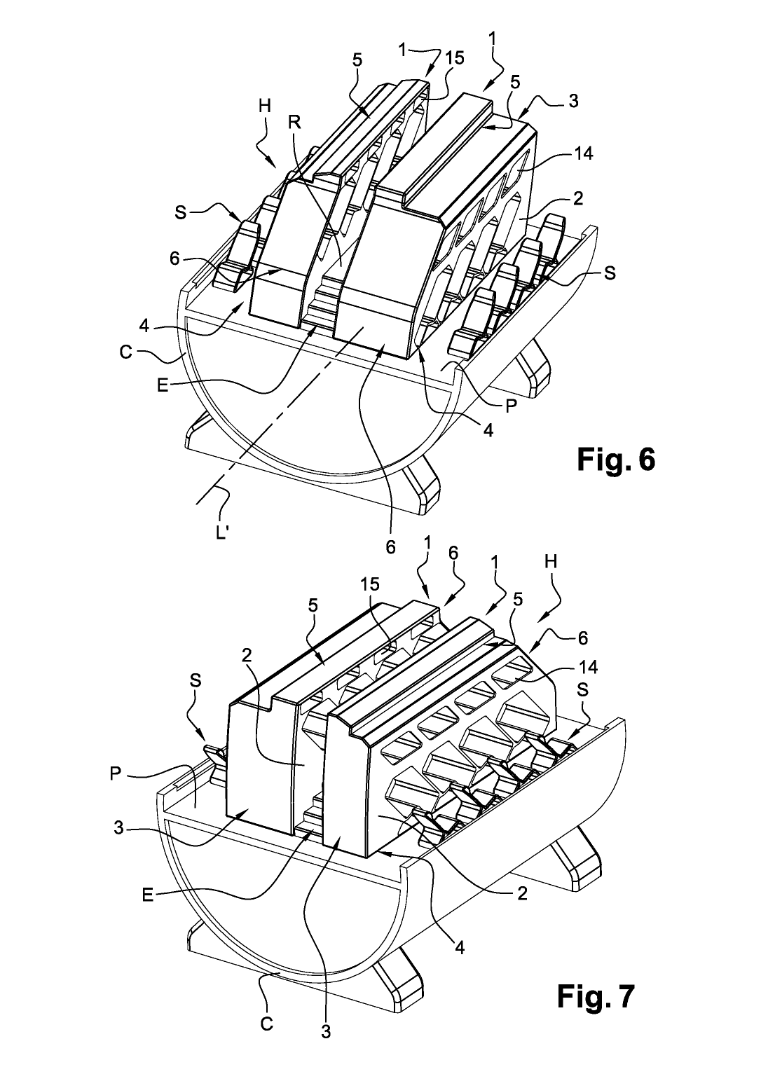

FIG. 6 is a schematic ¾ front perspective view of a section of a means of transport, in this case a plane, equipped with two rigid structures according to the invention mounted in parallel (for a better understanding, the upper part of the fuselage is not shown);

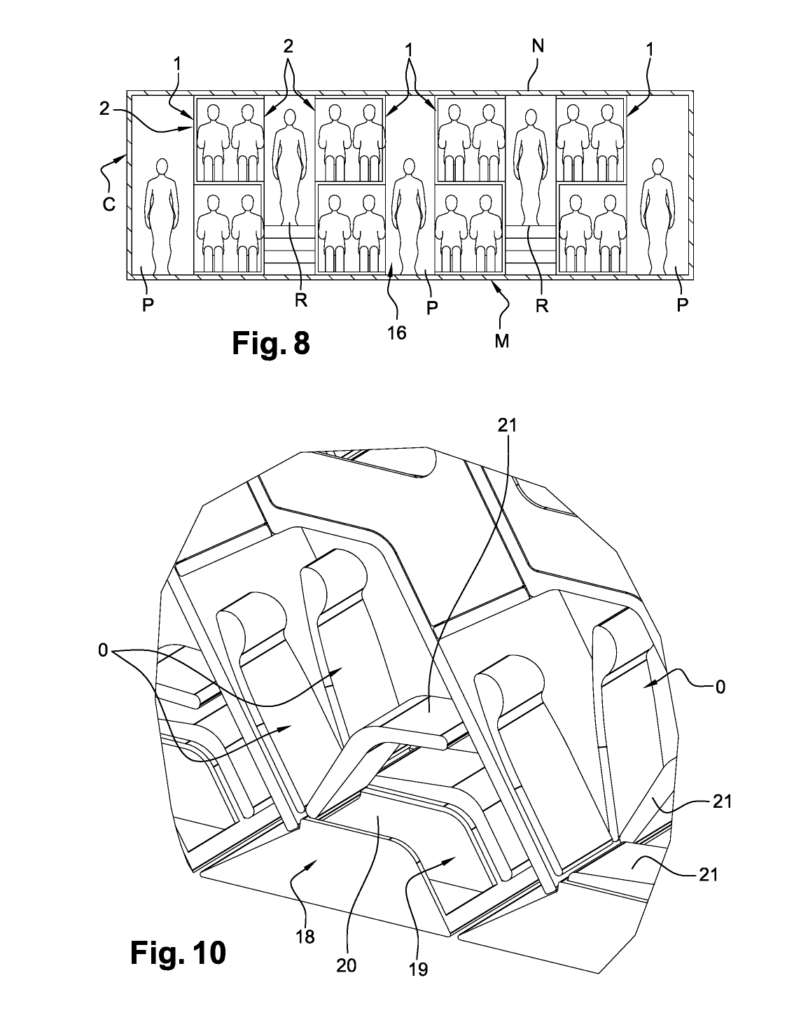

FIG. 7 is a schematic ¾ rear perspective view of the same plane section as that shown in FIG. 6;

FIG. 8 is a schematic cross section of a section of a means of transport illustrating the possibility to place in parallel a plurality of rigid modular structures according to the invention (4 in this case);

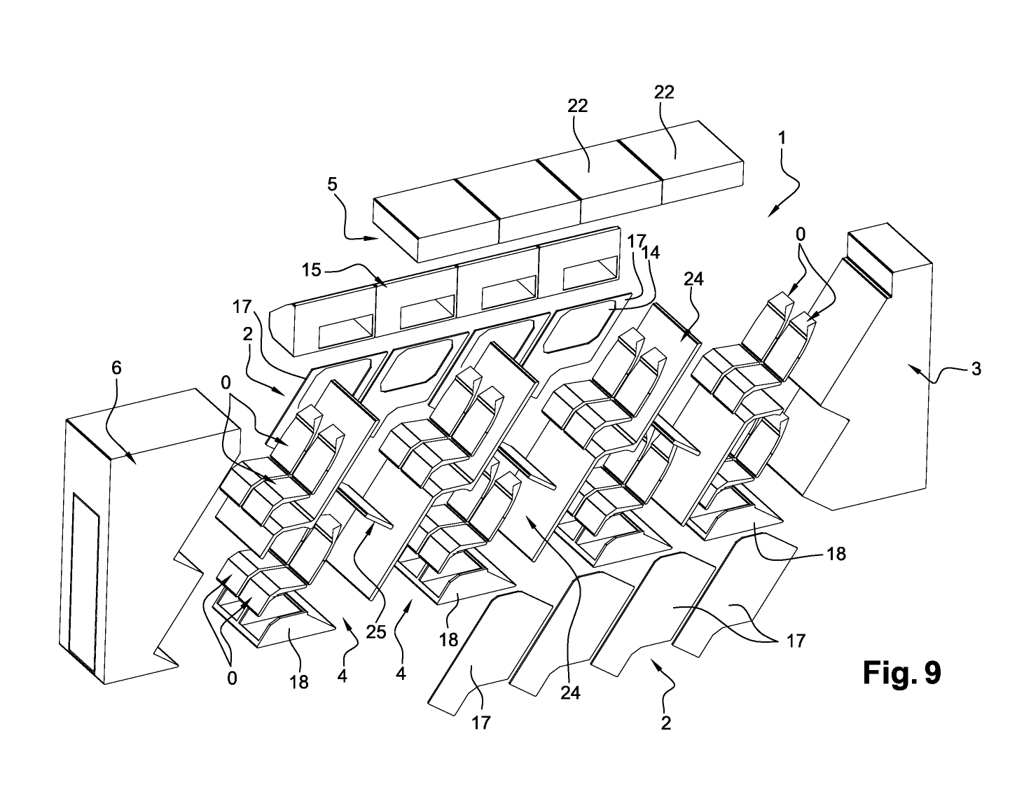

FIG. 9 is an exploded perspective view of an alternative embodiment of the rigid modulator structure according to the invention;

FIG. 10 is a partial perspective view illustrating a lower seating base block equipped with a luggage compartment accessible through a tilting flap formed by the associated seat structure ;

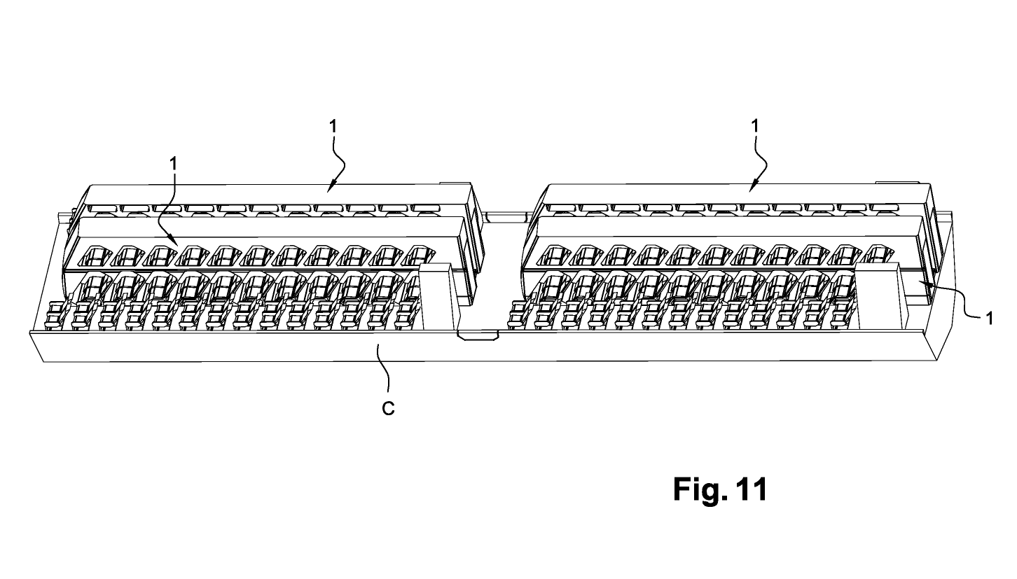

FIG. 11 is a partial perspective view of a plane cabin comprising 4 modular structures according to the invention.

The rigid modular structure 1 illustrated by FIGS. 1 to 5 is intended to be mounted in the compartment of a means of transport, in particular the cabin of a plane, without being thereby limited to this means of transport.

Such a mounting in the cabin of a plane is illustrated in particular by FIGS. 6 and 7.

The rigid modular structure 1 generally defines a volume of elongated shape along a longitudinal axis L. It comprises a plurality of cells on two levels, intended to receive passengers in seated position: lower cells A1 arranged one after the other along a direction parallel to the longitudinal axis L, on a lower level N1, and upper cells A2 arranged one after the other along a direction parallel to the longitudinal axis L, on an upper level N2 that is above the lower level N1.

This rigid modular structure 1 is delimited by two vertical walls 2 parallel to each other and that extend along the longitudinal axis L, by a rear structure 3, by a lower structure 4, by an upper structure 5 and by a front structure 6.
The lower structure 4 is intended to rest on the floor of the compartment of the means of transport and to be fixed to the latter, by any suitable fastening means (for example on rails equipping this floor).
The upper structure 5 is intended to be fastened to the ceiling of said compartment, by any suitable fastening means.

The cells A1 and A2 are arranged between the lateral walls 2 and between said rear 3, lower 4, upper 5 and front 6 structures.

The lower cells A1, identical to each other, are open in any one of the lateral walls 2, or they go right through the rigid structure 1.

The upper cells A2, identical to each other, are open in any one of the lateral walls 2, or they go right through the rigid structure 1.

In FIG. 1, the cells A1, A2 go right through the structure 1; whereas, in FIGS. 2 and 3, the lower cells A1 are open only in one of the lateral walls 2, the upper cells A2 being open in the other lateral wall 2.

These cells A1, A2 are intended to each receive at least one added seat intended for a passenger to seat.

The lower A1 and upper A2 cells have a substantially identical profile so as to cooperate at best and to limit the height of the whole rigid modular structure 1.

For that purpose, the general profile of each cell A1 and A2 is provided so as to allow a seated position for the passengers and is consisted as follows, as illustrated in FIG. 4:
a substantially horizontal seating base 7,
a back 8 substantially inclined with respect to the vertical,
a footrest 9 substantially perpendicular to the back 8,
a rest surface 10 for the legs, substantially parallel to the back 8,
a substantially horizontal ceiling 11,
a front face 12 substantially parallel to the back 8, and finally,
an upper area 13, intended to be located above the passengers' head, substantially perpendicular to the inclined back 8, making the link between this back 8 and the ceiling 11.

To allow at best the cooperation of the lower A1 and upper A2 cells, for the major part of them, the seating bases 7 of the upper cells A2 are located opposite the ceilings 11 of the lower cells A1; the passenger leg rest surfaces 10 of the upper cells A2 are located substantially in the continuation of the backs 8 of the lower cells A1; the footrest 9 of the upper cells A2 are located opposite the upper areas 13 of the lower cells A1; the distance between the lower structure 4 and the bottom point of the footrests 9 of the upper cells A2 is lower than the distance between this lower structure 4 and the ceilings 11 of the lower cells A1; this allows to maximally limit the height of the whole rigid structure 1.

Finally, the seating bases 7 of the upper cells A2 are located substantially directly vertically above the seating bases 7 of the lower cells A1.

As can be seen in FIGS. 6 and 7, the longitudinal axis L of the rigid structure 1 is parallel to the longitudinal axis L′ of the cabin C of the plane, and two rigid structures 1 may be mounted in parallel in the compartment H of this cabin C (but it may be contemplated to mount more than two rigid structures 1 in parallel in the case of a wider compartment H).

The passengers of the lower level N1 get to the lower cells A1 from one side of the rigid structure 1, and the passengers of the upper level N2 from the opposite side of the rigid structure 1 (FIG. 5). The passengers get to the lower cells A1 at a level P of the cabin C of the plane and the passengers get to the upper cells A2 at an upper level R of the cabin, itself raised with respect to the level P.

The lower A1 or upper A2 cells correspond to each other in the interval between two rigid structures 1, this in order to allow the passengers to share the same level of access P or R in said interval (FIGS. 6 and 7).

In these two FIGS. 6 and 7, we can observe the presence of stairs E provided between the two rigid structures 1 to allow the access to the upper level R of the upper cells A2. A row S of seats is provided on each side of the couple of modular structures 1.

A lateral window 14 pierces the window 2 at the end of each upper cell A2, opposite the access opening. Such a window 14 may also be provided in the wall 2 of the lower cells (opposite the access opening).

The modular structure 1 according to the invention proposes an improvement of the comfort of the passengers of the means of transport, in particular in a plane, without reducing the passenger carrying capacity thereof.

Due to the fixation of its lower 4 and upper 5 structures to the floor and to the ceiling of the compartment, respectively, it participates to the rigidity thereof, also improving the passenger security.

As can be seen in FIGS. 3 to 7, the upper structure 5 integrates luggage compartments 15. These luggage compartments 15 may also be carried by the sides of the upper structure 5, for example to be positioned above a lateral aisle, being accessible from this aisle or from the inside of the cells.

FIG. 8 shows a partial cross section of a cabin C of a plane equipped with two couples of modular structures 1 separated by an aisle 16.

Each modular structure 1 is fixed to the floor M of the cabin C by any suitable means and to the ceiling N also by any suitable means.
Here, each cell A1, A2 allows the accommodation of two passengers.

The different constitutive elements 2, 3, 4, 5 and 6 of the modular structure 1 may be made single-piece, or each from different parts assembled together, in particular to define the passenger receiving cells herein comprising two juxtaposed places and hence each receiving two seat structures O.

A possible embodiment of the rigid modular structure 1 is illustrated in FIG. 9, on which it can be seen that:
the vertical walls 2 are made by an assembly of panels 17 (for example lower panels and upperpanels), defining the openings of access to the cells A1, A2, and including for some of which said lateral windows 14;
the rear structure 3 is in the form of a caisson whose front face forms the rear part (back) of the cells of the last row, and is shaped accordingly.
   This rear caisson-shaped structure 3 advantageously includes an access opening (not shown), possibly closed by a door, to provide a technical room, a toilet room or other.
The lower structure 4 herein comprises lower seating base blocks 18 arranged so as to receive and support the seat structure O of the lower cells.
   As illustrated in FIG. 10, these lower seating base blocks 18 each integrate a luggage compartment 19 whose upper opening 20 is associated with a closing flap formed by the seating base 21 of the seat structure O, provided tiltable.
   In an alternative embodiment, lower luggage compartments 19 may be acceded laterally, through an opening being open to the juxtaposed aisle.
   As mentioned hereinabove, the lower seating base blocks 18 are intended to be fixed to the floor M of the compartment H of the cabin C, for example by means of the longitudinal rails usually present in said floor M of a plane cabin.
The upper structure 5 herein comprises a ceiling base 22 (single-piece or made of different parts assembled together), whose upper part is intended to be fixed to the ceiling of the cabin compartment, and whose lower part forms the top of the upper cells.
   The ceiling bases 22 integrate luggage compartments 15, or serve as supports for such luggage compartments 15, fixed laterally and to the compartment ceiling.
The front structure 6 is in the form of a caisson whose rear face forms the front part of the cells of the first row, and is shaped accordingly to conform at best said opposite cells. This front caisson-shaped structure 6 advantageously includes an access opening, possibly closed by a door, to provide a technical room, a toilet room or other.
   As an alternative, this front structure 6 may be in the form of a simple front structural and decorative panel.

The lower and upper cells A1, A2 are delimited between the lateral walls 2, the rear structure 3, the lower structure 4, the upper structure 5 and the front structure 6, by means of bent panels 24 associated with spacers 25.

The bent panels 24 may be solid, indented or perforated; they are adapted to separate two couples of lower and upper cells in the longitudinal direction. They are fixed, in upper part, to the upper structure 5 and/or to the ceiling of the compartment H of the cabin C, and, in lower part, to the lower structure 4 and/or to the floor of the compartment H of the cabin C.

They each include at least one partition for separating the lower and upper cells and an upper cell seating base.
The front structure 6 serves as a support for the opposite bent panel 24 for the passengers of the first row of the modular structure 1.

The spacers 25 connect two bent panels 24, or one bent panel 24 with the rear structure 3 or with the front structure 6.

They allow to rigidify the modular structure 1.

These spacers 25 serve as footrests 9 for the upper cells A2 and as upper area 13 for the lower cells A1; they may be planar or bent according to the versions and to the desired comfort.

Consoles for the light and for the oxygen system may be provided in upper part of the cells. On the other hand, screens may be provided in or against the rear face of the bent panels 24.

The lateral walls 2 are generally vertical, but they may be locally deformed, for example to provide the passengers with a little more space (in particular at the shoulders), or for the luggage.

FIG. 11 schematically illustrates an example of implantation of 4 modular structures 1 in a plane cabin section.

Such a structure 1 according to the invention offers a very good strength to stresses, in particular to the vertical and longitudinal stresses. In case of accident, the efforts generated by the weight of the structure, of the passengers and of the luggage are supported and distributed by the different structural elements, in particular the bent panels and the spacers.

It allows to accommodate more passengers and with a better comfort than in a conventional configuration.
The modular aspect of such a structure allows to very easily remove or reposition it to adapt the configuration of the compartment, for example according to the seasons.
Such a structure also allows to optimize the volumes (luggage compartments under the lower seating bases, and above or aside the upper cells; use of the vertical space (presence of 2 levels); integration of the toilets and storing spaces at the ends).
It facilitates the access and above all the evacuations thanks to the important number of aisles present; and it optimizes the privacy of the passengers.

1-11. (canceled)

12. A double-level modular structure (1) intended to be mounted in the compartment (H) of a means of transport, between a floor (M) and a ceiling (N), for the passengers to seat,
which modular structure (1) comprises:
a general volume substantially elongated along a longitudinal axis (L),
a plurality of lower cells (A1), arranged one after the other along a direction parallel to said longitudinal axis (L) of the structure (1) and on a lower level (N1),
a plurality of upper cells (A2), arranged one after the other along a direction parallel to said longitudinal axis (L) of the structure (1) and on an upper level (N2) located above said lower level (N1),
such cells (A1, A2) being intended to each receive at least one seat structure (O) for a passenger,
the profiles of the lower cells (A1) of the lower level (N1) being identical or substantially identical to the profiles of the upper cells (A2) of the upper level (N2), each cell (Al, A2) having a general profile allowing a seated position, this profiles comprising:
a horizontal or substantially horizontal seating base (7),
a back (8) inclined with respect to the vertical,
a footrest (9),
a passenger leg rest surface (10),
a ceiling (11),
a front face (12) substantially parallel to the back (8),
said seating bases (7) of the upper cells (A2) being located opposite the ceilings (11) of the lower cells (A1);
wherein the structure consists in a rigid structure (1) delimited at least by—two vertical lateral walls (2), parallel to each other, extended along a direction parallel to said longitudinal axis (L),—a rear structure (3),—a lower structure (4) intended to rest on the floor (M) of said compartment (H), and to be fixed to the latter, and—an upper structure (5) intended to be fastened to the ceiling (N) of said compartment (H), and between which walls (2) and structures (3, 4, 5) are arranged said cells (A1, A2),
said lower (A1) and upper (A2) cells are open in any one of said vertical lateral walls (2),
the passengers getting to the lower cells (A1) of the lower level (N1) from the side of a vertical lateral wall (2) of the rigid structure (1) and at a first level (P) of the compartment (H) of the means of transport, and
the passengers getting to the upper cells (A2) of the upper level (N2) from the side of a vertical lateral wall (2) that is opposed to the preceding one of the rigid structure (1), and at a second level (R), raised with respect to said first level (P).

13. The modular structure (1) according to claim 12, wherein said rigid structure (1) is also delimited by a front structure (6) located in the continuation of the lateral walls (2), of the lower structure (4) and of the upper structure (5).

14. The modular structure (1) according to claim 12, wherein the modular structure includes a plurality of lower (A1) and upper (A2) cells identical or substantially identical to each other, in which:
said footrests (9) is substantially perpendicular to the back (8),
said passenger leg rest surface (10) is substantially parallel to the back (8), said rest surfaces (10) of the upper cells (A2) being substantially located in the continuation of the backs (8) of the lower cells (A1),
said ceiling (11) is substantially horizontal,
an upper area (13) intended to be located above the passengers' head is substantially perpendicular to the inclined back (8),
said footrests (9) of the upper cells (A2) are located opposite said upper areas (13) of the lower cells (A1),
the distance between the lower structure (4) and the bottom point of said footrests (9) of the upper cells (A2) is smaller than the distance between said lower structure (4) and said ceilings (11) of the lower cells (A1), and
said seating bases (7) of the upper cells (A2) are located substantially directly vertically above the seats (7) of the lower cells (A1).

15. The modular structure (1) according to claim 12, wherein said front structure (6) and/or said rear structure (3) are in the form of a caisson provided with at least one access opening, possibly closed by a door, to provide a technical room or a toilet room.

16. The modular structure (1) according to claim 12, wherein the modular structure is made by an assembly of elements made separately, i.e., at least,—bent panels (24),—bent panel spacers (25),—lower seating base blocks (18),—ceiling bases (22), and—panels (17) of lateral walls (2).

17. The modular structure (1) according to claim 12, wherein said upper structure (5) integrates or supports a plurality of luggage compartments (15).

18. The modular structure (1) according to claim 12, wherein each of said lower (A1) and upper (A2) cells include at least one seat structure (O) added on the seating base (7).

19. The modular structure (1) according to claim 18, wherein said lower structure (4) includes lower seating base blocks (18) supporting at least certain of the seat structures (O) of the lower cells (A1), and which seating base blocks (18) each integrate at least one luggage compartment (19) provided with an opening (20) associated with a closing flap, said opening (20) being located on the top of said lower seating base block (18) and the seating base (21) of said seat structure (0) being tiltable to form said closing flap.

20. The modular structure (1) according to claim 12, wherein each upper cell (A2) includes a window (14) in the wall (2) opposite to that of main access for the passengers.

21. An arrangement of a plurality of modular structures (1) according to claim 12 in the compartment (H) of a means of transport, wherein said modular structures (1) are placed side by side in said compartment (H), the longitudinal axes (L) thereof being parallel to each other, and wherein
the lower (A1) or upper (A2) cells correspond to each other in the interval between two modular structures (1), in order to share the same level of access (P) or (R) to the lower (A1) or upper (A2) cells in said interval.

22. The arrangement of a plurality of modular structures (1) according to claim 21, further comprising at least one row (S) of seats fixed to the floor (M) of the compartment (H) of the means of transport, on each side of the plurality of modular structures (1).

23. The modular structure (1) according to claim 13, wherein said front structure (6) and/or said rear structure (3) are in the form of a caisson provided with at least one access opening, possibly closed by a door, to provide a technical room or a toilet room.
